(19) United States
(12) Patent Application Publication
(10) Pub. No.: US 2016/0075381 A1
(43) Pub. Date: Mar. 17, 2016

(54) Axle Support of a Vehicle

(71) Applicant: Bayerische Motoren Werke Aktiengesellschaft, Muenchen (DE)

(72) Inventor: David KELLER, Muenchen (DE)

(21) Appl. No.: 14/946,964

(22) Filed: Nov. 20, 2015

Related U.S. Application Data
(63) Continuation of application No. PCT/EP2014/057443, filed on Apr. 11, 2014.

(30) Foreign Application Priority Data
May 22, 2013 (DE) 10 2013 209 375.6

(51) Int. Cl. B62D 29/04; B62D 21/03; B62D 21/02

(52) U.S. Cl. CPC B62D 29/041; B62D 21/02; B62D 21/03

(57) ABSTRACT

An axle support of a vehicle is provided in which at least one longitudinal member is formed from fiber composite plastic in the form of a braided profile. The braided profile may have one or more braided layers made of the reinforcement threads of the fiber composite plastic, and may be in the form of a hollow profile having at least in parts a braided core therein.

### CROSS REFERENCE TO RELATED APPLICATIONS

This application is a continuation of PCT International Application No. PCT/EP2014/057443, filed Apr. 11, 2014, which claims priority under 35 U.S.C. §119 from German Patent Application No. 10 2013 209 375.6, filed May 22, 2013, the entire disclosures of which are herein expressly incorporated by reference.

### BACKGROUND AND SUMMARY OF THE INVENTION

The invention relates to an axle support of a vehicle, in particular a passenger car, said support comprising at least one longitudinal member which is made of a fiber composite plastic. With regard to the prior art, reference is made only by way of example to German patent publication no. DE 10 2012 011 797 A1.

Axle supports, for example front axle supports of passenger cars, presently comprise metallic materials such as aluminum or steel. Integral components of such an axle support are typically two longitudinal members and one or more cross-members which connect the two longitudinal members with one another. The longitudinal members are often formed as hydroformed profiles (=profile produced by internal high pressure forming). On the longitudinal members and/or cross-members are provided mounting devices, for example for a control arm, steering gear or engine mounts. For fixing to the vehicle, the longitudinal member is in particular mounted from below onto the longitudinal member of the chassis or the so-called engine mount.

A disadvantage of known longitudinal members in axle supports is the (relatively) high weight caused by the metallic material. Further, the longitudinal member of an axle support plays a not insignificant role in particular with respect to the crash behavior of the vehicle, wherein current axle supports with metallic longitudinal members appear capable of improvement, to the extent that the energy which is introduced into the vehicle structure during collision can be yet more strongly dissipated by the deformation of the longitudinal member of the axle support. There also exists in the prior art a conflict of objectives between an actual desired crash behavior of the vehicle and the driving dynamics and acoustic behavior thereof. Specifically, while the axle support should have the most flexible structure possible in the event of a crash, the stiffest possible axle support is advantageous for good driving dynamics and acoustics.

Based on the prior art, the object of the invention is to provide a measure for weight reduction of a vehicle axle support, which while fulfilling the requirements of driving dynamics also imparts a positive crash behavior.

The object is achieved by an axle support, in which at least one longitudinal member of the axle support comprises a braided profile formed from fiber composite plastic, having one or more braided layers made of the reinforcement threads of the fiber composite plastic.

In an axle support according to the invention, a longitudinal member is made of a fiber composite plastic at least over substantial portions. Fiber composite plastics are materials which contain at least one fiber material and a matrix material. The appropriate materials are selected corresponding to the high requirements with respect to stiffness and strength and comprise in particular CFRP (carbon fiber reinforced plastics) and GRP (glass fiber reinforced plastics). Due to the fiber composite plastic structure, a longitudinal member provided according to the invention is characterized by a high stability with a simultaneous reduction in weight as compared with conventional metallic materials. In addition, a favorable crash behavior is imparted to the component through the fiber composite plastic, as the fiber composite structure can absorb more energy than a corresponding metallic material. The longitudinal member according to the invention is thus characterized by a high stiffness and strength and yet a very high energy absorption capacity, whereby a balanced profile of properties of the longitudinal member is achieved in relation to the mechanical properties, vehicle dynamics, acoustics and the crash behavior of the axle support comprising this longitudinal member.

As is typical in the aforementioned hydroformed profiles, the longitudinal member or the braided profile thereof may be formed at least partially as a hollow profile, which further reduces weight, improves crash behavior and enables a simple connection with other components. The hollow profile preferably comprises braided strata, i.e. it is formed as a braided profile, such that the reinforcement threads of the fiber composite plastic are braided into at least one braided layer, possibly also a plurality of braided layers provided one above the other (and thus form a sort of braided hose). Through the shape of the braided profile, a good compromise between high design freedom of an axle support longitudinal member according to the invention on the one hand and very good mechanical properties on the other hand can be achieved. Due to the relatively high density of a braid as compared, for example, to knitting or weaving, the longitudinal member may be represented with high strength and stiffness, which also has an advantageous effect on acoustics and driving dynamics, wherein however a sufficiently high deformability in the event of a crash is provided by means of the braid structure. A multiple overbraiding of a braided profile may be made, whereby a braided profile results which is made from a plurality of braided layers. Constructed in this way, the crash behavior is more effectively decentralized and a high energy absorption over a wider area of the longitudinal member is possible.

Along the length of the longitudinal member, the braided profile (e.g., a braided hose) may comprise regionally differing wall thicknesses, i.e. the braided layer or braided layers may be formed differently across the length of the longitudinal member. For example, the direction of braiding may be turned several times and thus a braided core which is typical for use in the production of a braided hose may be overbraided several times in some places. Another embodiment for a design of the braided layers which differs across its length comprises a different orientation of the reinforcement threads (for example carbon or glass fiber threads) which make up the braided layer(s). This braiding may comprise a directionality which is adapted to the profile course of the longitudinal member and/or the respective local loading direction. This direction or orientation of the braiding can be variable along the member, which can be represented, for example, by a differing braiding speed or feed rate during braiding of the reinforcement threads.

As already briefly mentioned, a braided core is usually required for the production of a braided profile, on which braided core the braiding of the reinforcement threads takes place. It is typical here during the production of a braided profile to build the braiding on a braided core, which is removed after completion of the braid, for example dissolved. According to a development of the present invention, the braided core can remain within the braided profile at least in parts, meaning that the braided profile contained in the axle support contains in turn a braided core or the braided core at least in parts. With a braided core which remains at least in places in the braided profile, an improved acoustic damping of the longitudinal member may result and the deformation behavior thereof (in particular in the event of a crash) can be targetedly reached. The braided core can be made of any suitable material; particularly suitable for this purpose are foam materials.

While a further weight savings is the result of the removal of the braided core, a braided core remaining in the braided profile or braided hose may display a positive effect, in particular acoustically, for which reason the braided core may also remain only in certain acoustically-critical regions in the braided profile. As a manufacturing method for a partial or sectional removal of the braided core may be considered, for example, blowing out with a blasting agent or dissolving with a solvent. Furthermore, the braided core itself may receive (additional) inserts, for example comprising plastic or metal. These inserts (of course, only a single insert is also possible) are braided in during production of the braided profile and after curing of the plastic material form a unit with the longitudinal member of the axle support. Such inserts may form screw points or reinforcements in the profile, thus forming for example the necessary connection points between the axle support and the vehicle body, for example the aforementioned engine mount. By means of such inserts, so-called bulkheads may also be formed within the braided profile or the longitudinal member, which support the profile cross-section of the longitudinal member in areas such as the connection of wheel-guiding control arms.

The braided profile may comprise textile reinforcements. Such textile reinforcements may be obtained, for example, by the addition of stitching, tufting or weaving of the material. In the case of a crash, the acting energy can hereby be extended to the total longitudinal member, whereby strong local damage can be reduced. Furthermore, the fiber composite plastic of the at least one longitudinal member according to the invention may comprise at least one damping layer, preferably made from a viscoelastic material. The provision of such a damping layer improves the acoustic behavior of the longitudinal member, in particular in that the damping is thus directly integrated into the structure of the longitudinal member. As a result, external components serving this function can be dispensed with, whereby the physical structure of the axle support and the corresponding vehicle axle are simplified.

Said damping layer is ideally placed between overlapping or superimposed braided layers, but may also be applied between a braided stratum and the braided core or on the outside of the braid from the reinforcement threads. For weight and cost reasons, it may be advisable not to provide the damping layer over the entire length of the braided profile of the longitudinal member, but rather as local patches only in vibration-critical areas. The vibration damping within the component is based on the internal friction in said damping layer. This is ideally used such that the damping layer is loaded by shearing forces between the adjacent braided strata. As a result, those places with high shear stress can be determined for the vibration modes to be damped, and the proposed damping measures can be employed locally there.

An axle support according to the invention may further be provided with a structural element comprising fiber composite plastic, thus in addition to at least one cross-member also a shear field or any other sort of mounting devices for the fixing of other components. In addition to a further weight reduction, such structural elements simplify the connection with the axle support due to their material, and contact corrosion is thus prevented. With regard to the aforementioned cross-member, this may be connected by means of adhesive bonding to the longitudinal members via node elements, which are preferably formed by injection molding or formed through an SMC (sheet molding compound). Through the connection types shown here, the longitudinal member and the cross-member may be stably fixed to one another. The components are integral parts of the axle support, whereby the energy absorption in the event of a crash is decentralized, and strong local damage is prevented. Further, additional connecting elements, such as rivets, screws and the like, may be dispensed with, which simplifies the production of the axle support. In this context it should be noted that, due to the braiding, it is possible to represent almost any shape. In particular, a longitudinal member of an axle support according to the invention may also comprise a bifurcation, i.e. be braided with a bifurcation. Such a bifurcation is possible, for example, in order to provide a connection stub (alternatively to the above-mentioned node element) for a cross-member or otherwise a cross-connection between the (typical) two longitudinal members of an axle support according to the invention.

Hereafter are again listed advantages which can be reached with the inventive axle support or the developments thereof described thus far: The mechanical properties of the longitudinal member and the axle support, such as in particular static and dynamic stiffness, are improved. The strength of the longitudinal member and the axle support is increased. The crash behavior of the longitudinal member and the axle support is improved through the material-optimized fiber composite construction. Locally acting deformation energy is decentralized and dissipated, so that local deformation or damage can be avoided. Driving dynamics and acoustics of the longitudinal member and the axle support can be improved. The weight of the longitudinal member according to the invention and the axle support according to the invention is lower with equal or better functional properties than the conventional construction of steel or aluminum. An integration and fixing of additional components such as cross-members, transverse control arms and/or mounting provisions for other components and/or a shear field can be simplified. Contact corrosion is reduced.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a top view of a part of an axle support according to a first embodiment of the present invention,

FIG. 2 shows a sectional view of an axle support in a connection region according to a second embodiment of the present invention, and

FIG. 3 shows a three-dimensional view of a connection region of an axle support according to the invention according to a third embodiment of the present invention.

### DETAILED DESCRIPTION OF THE DRAWINGS

In the figures only the parts and components of interest here are represented. All other elements, for example the axle supports, are omitted for the sake of clarity. In all the figures, like reference characters indicate like components.

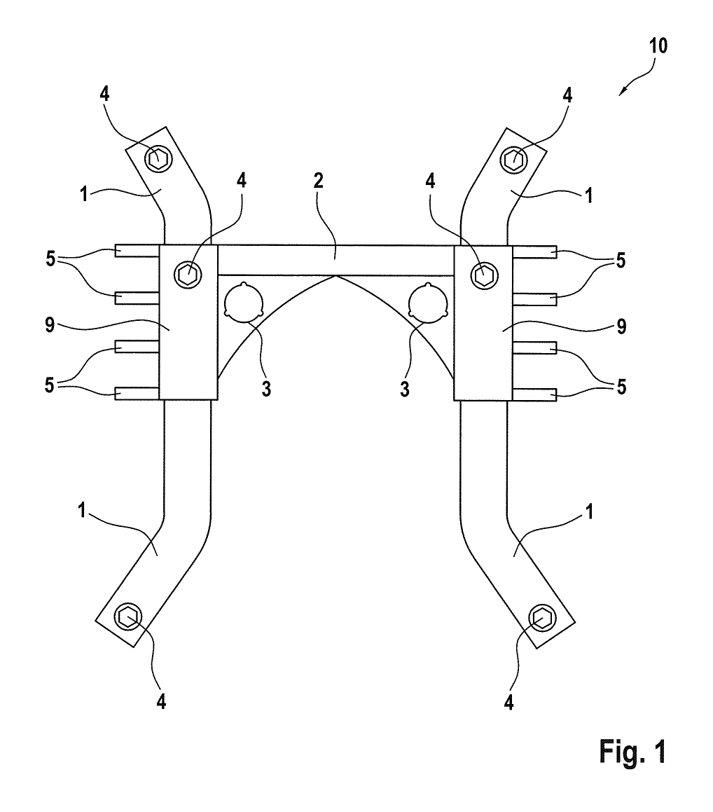

FIG. 1 shows in detail an axle support 10 having two longitudinal members 1 and a cross-member 2 connecting the two longitudinal members 1, said cross-member being designed in the form of a transverse bridge with two engine mounts 3. The longitudinal members 1 are formed at least in parts, preferably completely, as a braided profile made from a fiber composite plastic, preferably GRP or CFRP, and thus have a low intrinsic weight with very good stability. The longitudinal members 1 each comprise three screws 4, by which the axle support 10 can be mounted, for example, on a vehicle chassis. In addition, the longitudinal members 1 comprise control arm connections 5. Here may be fixed a transverse control arm for the wheel suspension.

The longitudinal member 1 and the cross-member 2 are connected with each other and thus integrated in one another via a node element 9, for example via an SMC-node element (sheet molding compound). Additional fastening or connecting elements are therefore not necessary. A connection of the longitudinal member 1, the cross-member 2 and the node element 9 may occur for example through adhesion or by screwing together. The connection is thus designed such that no settling behavior of the components occurs.

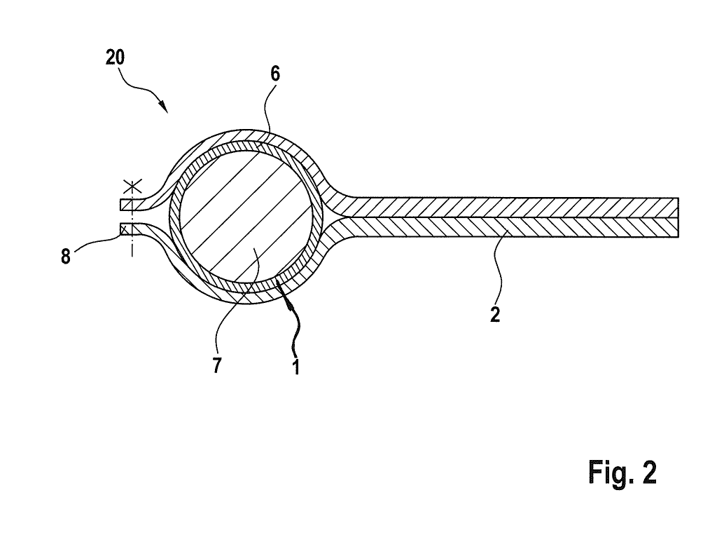

FIG. 2 shows a sectional view of a part of an axle support 20 according to a second embodiment. It can be seen that the longitudinal member 1, only represented in cross-section, comprises a braided hose or braided profile 6, within which a braided core 7 is further contained. By means of the braided core 7, the acoustic damping of the axle support 20 is increased, and the deformation characteristic of the axle support 20 is adjusted.

This representation according to FIG. 2 also shows a possible connection between the longitudinal member 1 and a cross-member 2. The shape and configuration of the cross-member 2 is not individually limited. In order to provide particularly good stability, the cross-member 2 may here comprise for example two metallic workpieces which are nearly parallel or arranged in mirror image, for instance two bowl-shaped plates, which, as shown figuratively, enclose the longitudinal members 1 with their end portions. As can be seen, a so-called jointed flange 8 is hereby formed and an adhesive connection or screw connection may be provided at this point, wherein care is taken that no settling behavior of the components which impairs a secure connection occurs.

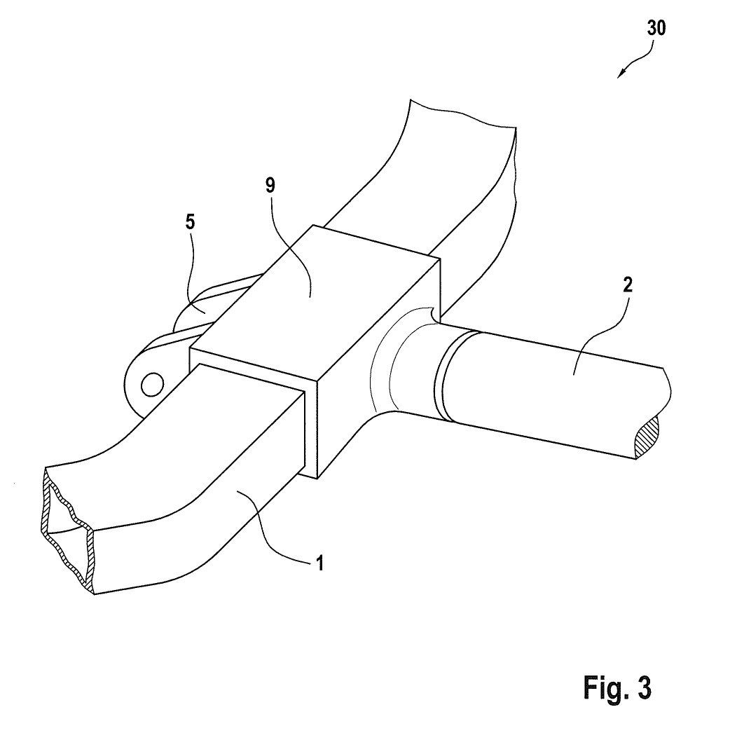

FIG. 3 shows another embodiment of a connection point of a longitudinal member 1 with a cross-member 2 in an axle support 30, which otherwise like the axle support 20 of FIG. 2 may be constructed similarly to the axle support 10 in FIG. 1. In FIG. 3 can be seen in detail that the longitudinal member 1 is connected together with the cross-member 2 via a node element 9 similar to FIG. 1, for example by an SMC-node element (sheet molding compound), and the components are thus integrated into one another. Additional fastening means or connecting elements are not necessary. Through the preferred embodiment of the node element 9 and likewise the fiber composite component, a durable and simple connection between the axle support parts can be produced with a very low intrinsic weight of the axle support 30.

In this embodiment, the cross-member 2 is formed as a round profile and inserted into a suitable mount provided on the node element 9 for this purpose. In principle, however, other shapes for the cross-member 2 are conceivable. Here too, the longitudinal member 1 comprises a control arm connection 5 on the node element 9. Here may be fixed a transverse control arm for the wheel suspension.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An axle support of a vehicle, comprising:
at least one longitudinal member at least partially formed from a fiber composite plastic,
wherein the longitudinal member includes a fiber composite plastic braided profile having one or more braided layers formed by reinforcement threads of the fiber composite plastic.

2. The axle support according to claim 1, wherein the braided profile is at least in parts a hollow profile.

3. The axle support according to claim 1, wherein the braided profile includes at least in parts a braided core located within an interior region of the braided profile.

4. The axle support according to claim 3, wherein the braided profile includes at least in parts a braided core located within an interior region of the braided profile.

5. The axle support according to claim 1, wherein the braided profile includes textile reinforcements.

6. The axle support according to claim 1, wherein the braided profile includes at least in parts a damping layer.

7. The axle support according to claim 6, wherein the damping layer is formed from a viscoelastic material.

8. The axle support according to claim 1, further comprising:
at least one of a cross-member and a mounting device for the fixing of a further component or a shear field,
wherein the at least one of the cross-member and the mounting device being formed from fiber composite plastic.

9. The axle support according to claim 8, further comprising:
a node element formed as an injection molded part or with sheet molding compound,
wherein
the at least one of the cross-member and the mounting device is the cross-member, and
the node element is arranged to connect the longitudinal member to the cross-member via an adhesive connection.

10. The axle support according to claim 1, wherein the one or more braided layers are non-uniform across a length of the longitudinal member, such that the braided profile has at least one of a different wall thickness, different reinforcement thread directions and a bifurcation.

11. The axle support according to claim 3, wherein the braided core includes at least one insert made from a different material than the braided core.
